(19) United States
(12) Patent Application Publication
(10) Pub. No.: US 2016/0140594 A1
(43) Pub. Date: May 19, 2016

(54) Automatic Discount System and Method

(71) Applicant: Gary T. Pope, Mountain Home, ID (US)

(72) Inventor: Gary T. Pope, Mountain Home, ID (US)

(21) Appl. No.: 14/546,205

(22) Filed: Nov. 18, 2014

(51) Int. Cl. G06Q 30/02; G06Q 30/06; G06Q 20/12

(52) U.S. Cl. CPC G06Q 30/0222; G06Q 20/12; G06Q 30/0224; G06Q 30/0633; G06Q 30/0267

(57) ABSTRACT

An online automatic discount system for use with a wide area network and interfaced mobile device includes a computer server connected to the internet and accessible from the mobile device. The server includes a processor and includes a memory having programming and that includes a seller database having a plurality of member seller records and a buyer database having a plurality of member buyer records. Each seller record includes product and coupon data. The method includes receiving purchase data from a respective buyer indicative of a product selected by the buyer's interfaced mobile device. The method includes determining from the seller database if a coupon is available and associated with the product selected by the respective buyer and, if so, delivering the coupon to the interfaced mobile device associated with the respective buyer. If no coupon is available, an alternative product is suggested for which a coupon is available.

### BACKGROUND OF THE INVENTION

This invention relates generally to coupon management systems and, more particularly, to a system and method for automatically delivering coupons to a buyer's mobile device when associated products are selected for purchase.

Traditionally, a consumer must proactively locate coupons related to products he wants to purchase, such as in a newspaper, or online. Then, he must cut or print them out and carry them to a retail store where they may be redeemed during checkout. The process described may also be referred to as “pulling” coupons. The effectiveness of using coupons in this manner depends on a consumer having the coupons readily available for review and having sufficient time and motivation to review and cut them out.

Although the traditional method of receiving product discounts is effective for a motivated consumer and one that has sufficient print or computer access to published coupons, the use of coupons is often ineffective due to the amount of time required to obtain them, the risk of losing the coupons before arrival at an appropriate retail store, and other reasons. In addition, printing or publishing the coupons can be a heavy burden on the manufacturers who choose to use coupons as a means for promoting sales of their products.

Therefore, it would be desirable to have a system and method for automatically delivering or “pushing” coupons to a buyer's mobile device when associated products are selected for purchase. In other words, it would be desirable for coupons to be pushed to a buyer when without any proactive action by the buyer other than to select the product. Further, it would be desirable to have a system and method in which an alternative product for which a coupon is available is suggested to the buyer when no coupon is available for the buyer-selected product. In addition, it would be desirable to have a system and method in which advertisements or coupons are strategically pushed to a buyer's mobile device to urge the buyer to continue shopping.

### SUMMARY OF THE INVENTION

An online automatic discount system for use with a wide area network and interfaced mobile device according to the present invention includes a computer server connected to the internet and accessible from the mobile device. The server includes a processor and includes a memory having programming and that includes a seller database having a plurality of member seller records and a buyer database having a plurality of member buyer records. Each seller record includes product and coupon data. The method includes receiving purchase data from a respective buyer indicative of a product selected by the buyer's interfaced mobile device. The method includes determining from the seller database if a coupon is available and associated with the product selected by the respective buyer and, if so, delivering the coupon to the interfaced mobile device associated with the respective buyer. If no coupon is available, an alternative product is determined from the seller database for which a coupon is available.

Therefore, a general object of this invention is to provide a system and method for automatically delivering coupons to a buyer's mobile device when associated products are selected for purchase.

Another object of this invention is to provide a system and method, as aforesaid, in which products are selected for purchase by scanning the product's barcode or QR code and then a coupon associated with the selected product is “pushed” to the buyer's mobile device.

Still another object of this invention is to provide a system and method, as aforesaid, in which an alternative product for which a coupon is available is suggested to the buyer when no coupon is available for the buyer-selected product.

Yet another object of this invention is to provide a system and method, as aforesaid, in which coupons pushed to the buyer's mobile device are redeemed automatically when the buyer's mobile device is connected to a point-of-sale device.

A further object of this invention is to provide a system and method, as aforesaid, in which advertisements are delivered to the buyer's mobile device when the buyer indicates he is done shopping so as to urge the buyer to continue shopping.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a block diagram of an online automatic discount system according to a preferred embodiment of the present system illustrating how the system is accessible over the internet and operated as a network server system;

FIG. 2 is a block diagram of the online automatic discount system as in FIG. 1 illustrating the network server system;

FIG. 3 is a flowchart illustrating the logic performed by a processor to perform a setup process of the system;

FIG. 4 is a flowchart illustrating the logic performed by a processor to perform a consumer buying event in which coupons associated with selected products are automatically pushed to the buyer's mobile device;

FIG. 5a is a flowchart illustrating the logic of a checkout routine and manual coupon redemption; and

FIG. 5b is a flowchart illustrating the logic of a checkout routine and automatic coupon redemption.

### DESCRIPTION OF THE PREFERRED EMBODIMENT

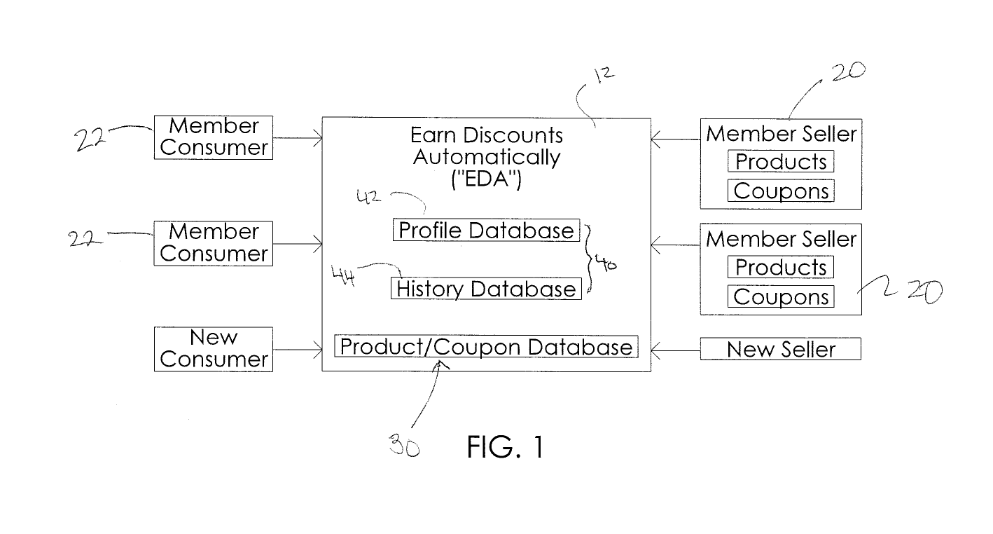

A system and method of automatically delivering discounts (in the form of coupons) to the mobile device of a buyer who has selected products for purchase using the mobile device will now be described in detail with reference to FIGS. 1 to 5b of the accompanying drawings. The system will also be referred to as an automatic discount delivery system.

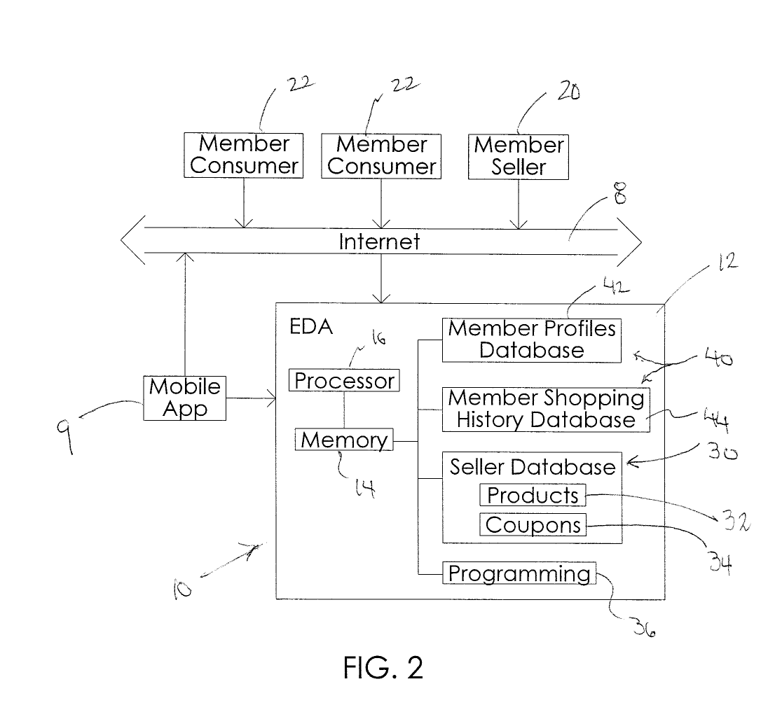

The online automatic discount delivery system 10 includes at least one computer 12, such as a network server, operably connected to the internet 8 or other wide area network and accessible by remote computers in a traditional manner (FIGS. 1 and 2). Specifically, the server is configured to be accessed by mobile devices such as smart phones, tablets, or the like having an appropriate user interface such as a “mobile app” installed on the device. The online automatic discount system 10 is designed to be used by member sellers 20 and by member buyers 22 as will be described below. The system 10 may be configured and managed by an administrator having security access to all aspects of the computer, memory, including data and programming.

The computer 12 may include a memory 14 configured to store a plurality of programming instructions 36 and a processor 16 configured to selectively execute the program instructions in a manner that operates the system 10 as will be described below. The memory 14 may also be structured so as to store a plurality of data structures such as one or more databases and data that may be stored and manipulated by operation of the programming instructions.

A seller database 30 may be stored in memory 14 and includes a plurality of member seller records. Each member seller record may include data structures for storing a seller identifier, a plurality of product records 32, and a plurality of coupon records 34 associated with respective product records 32. A product seller is able to become a member of the automatic discount system 10 and upload data regarding products to be offered for sale—such as in a retail or grocery store—and to upload coupon data indicating discounts to be offered to buyers who purchase associated products.

Similarly, a buyer database 40 may be stored in memory 14 and includes a plurality of member buyer records. Each member buyer record may include data structures for storing a buyer profile record 42 (including a buyer identifier) and a purchase history record 44. Each buyer profile record 42 may include personal information, contact information, or other demographic information that may be of interest to member sellers for advertising purposes or in formulating future coupon offers. The purchase history record 44 provides an ongoing record of a respective buyer's product purchases over time, by category, or by some other metric or classification. The system 10 includes programming by which a respective buyer can review his former product purchases prior to, during, or after shopping as will be described in more detail later.

The automatic discount delivery system 10 may be accessed by a member buyer 22 or member seller 20 through a graphic user interface delivered over the internet 8 (FIG. 2). The internet, of course, may be accessed from a buyer's mobile device 9. More particularly, the user interface may be downloaded to a respective buyer's mobile device 9 such as a smart phone, tablet, or the like. The mobile device 9 may then connect to the computer 12 via a wireless connection for use as will be described below.

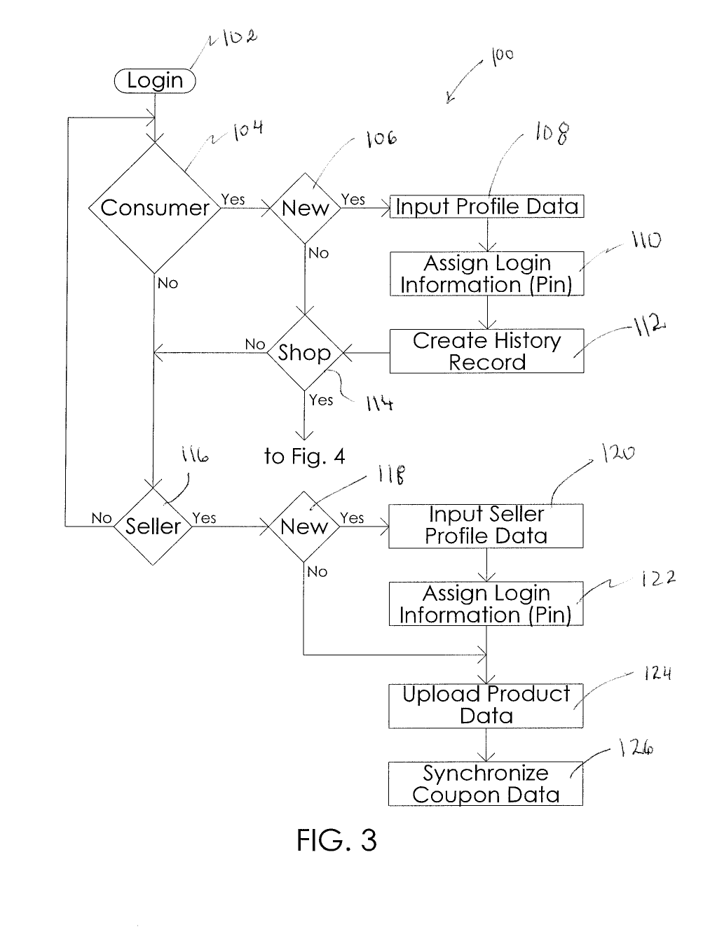

Operation of the system 10 according to an exemplary process is illustrated in the flowcharts of FIGS. 3 through 5b and will be described below. It is understood that the steps of the process are carried out by the processor 16 executing programming stored in memory 14. A setup process 100 includes programming for receiving seller and buyer data into respective databases as described above.

As shown in FIG. 3, the setup process 100 begins at step 102 with a user logging in to the user interface and then proceeds to step 104. At step 104, the processor 16, under program control, determines if the user is a consumer (i.e. a buyer), such as by a menu driven or touch screen user interface on a mobile device 9 that is interfaced/connected to the computer 12.

If it is determined that the user is a consumer/buyer, then the process 100 proceeds to step 106; otherwise, the process 100 proceeds to step 116. At step 106, the processor 16 determines if the consumer is new to the system 10 or is already a member. If the consumer is new, then the process 100 proceeds to step 108; otherwise, control is passed to step 114. At step 108, the new buyer is prompted to profile data, such as name, address, or other demographic information such as household income, buying preferences, occupation, recreation preferences, family information, and other information that may be desirable to member sellers to assist in advertising to the respective buyer, formulating product and coupon offerings.

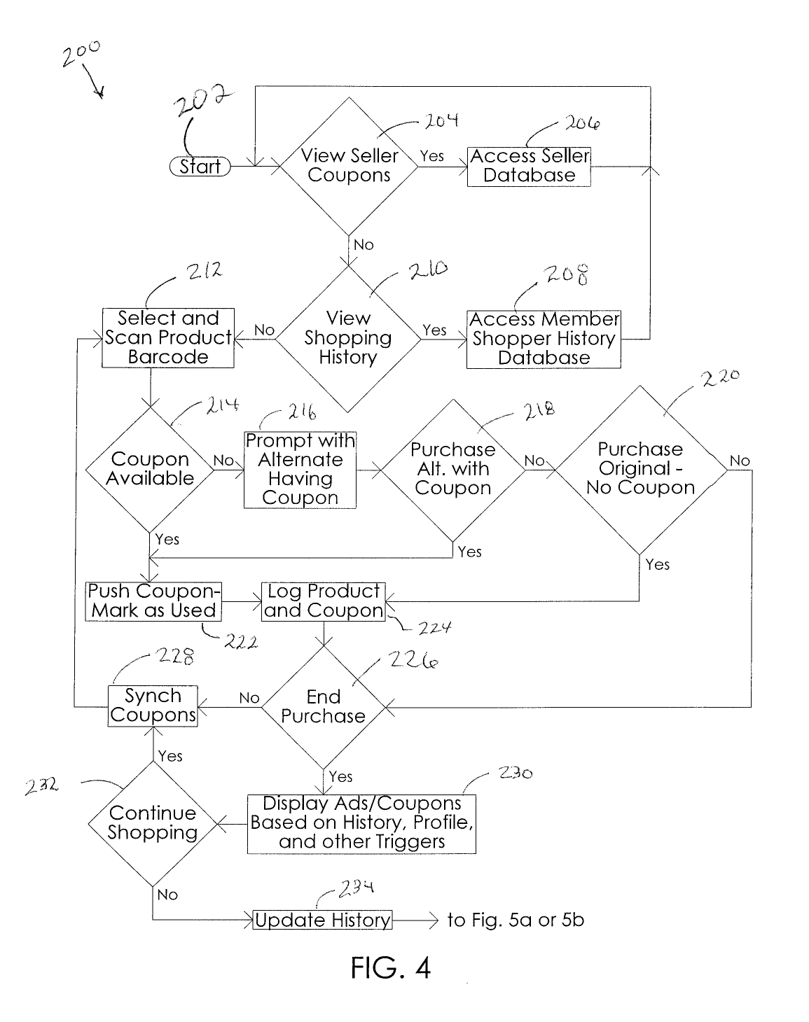

The process 100 then proceeds to step 110 at which a buyer identifier, login data, or PIN (personal identification number) is assigned for future login purposes. It is important that a respective buyer be identified upon login so that product purchases, purchase history, and other actions can be properly recorded as will be discussed below. The process 100 then proceeds to step 112 at which a purchase history record 44 is created, stored in memory, and associated with the buyer identifier. The process 100 proceeds to step 116. At step 114, the process 100 determines if the new member buyer 22 desires to start a product shopping event and, if so, the process 100 proceeds to the process 200 illustrated in FIG. 4; otherwise, the process 100 proceeds to step 116.

At step 116, the processor 16, under program control, determines if the user is a seller, such as by a menu driven or touch screen user interface on a mobile device 9 that is interfaced/connected to the computer 12. If it is determined that the user is a seller, then the process 100 proceeds to step 118; otherwise, the process 100 proceeds to step 104 or, alternatively, exits the process 100 altogether. At step 118, the processor 16 determines if the seller is new to the system 10 or is already a member. If the consumer is new, then the process 100 proceeds to step 120; otherwise the process 100 proceeds to step 124. At step 120, the new member seller 20 is prompted to input seller profile information, such as contact information. The process 100 proceeds to step 122 at which a seller identifier, login data, or PIN (personal identification number) is assigned for future login purposes. The process then proceeds to step 124.

At step 124, the processor 16 enables a member seller 20 to upload product data and configures the uploaded data in respective data structures in the seller database 30 in memory 14. The uploaded product data is associated with the respective member seller 20. When all product data is uploaded, the process 100 proceeds to step 126. At step 126, the processor 16 enables the member seller 20 to upload coupon data and coordinates its storage thereof in memory 14. The coupon data is synchronized with coupon data already on the seller database 30 to be sure there are no duplicates or other errors or inconsistencies. Process 100 ends after step 126 is completed.

As shown in FIG. 4, an automatic discount delivery process 200 begins at step 202 and may, for instance, be activated when a member buyer 22 chooses to shop, such as step 114 (FIG. 3). The process 200 proceeds to step 204. At step 204, the processor 16 determines if a respective buyer 22 has chosen to view available seller coupon records and, if so, the process 200 proceeds to step 206; otherwise, the process 200 proceeds to step 210. At step 206, coupon records 34 from the seller database 30 are delivered to the user interface, such as the buyer's mobile device 9. It is understood that a member buyer 22 may want to know what coupons are available for associated products in that it may have impact on what products he selects for purchase from a respective store. The process 200 then proceeds to step 204.

At step 210, the process 200 determines if a logged in member buyer 22 desires to view the purchase history record 44 associated with the respective member buyer 22, i.e. a record of his past purchases, and, if so, the process 200 proceeds to step 208; otherwise, the process 200 proceeds to step 212. It is understood that reviewing one's purchase history record 44 may help to remind a buyer of products that he wants to purchase again or to avoid. At step 208, the processor 16 delivers the purchase history record 44 associated with the member buyer's identifier (which is stored in the buyer database data structure) to the user interface, such as the buyer's mobile device 9. The process 200 then returns to step 204.

At step 212, the processor 16 receives product purchase data from a member buyer 22, such as a product UPC code scanned or photographed by the mobile device 9 associated with the logged in member buyer 22. The process 200 proceeds to step 214. At step 214, the processor 16 accesses the seller database 30 so as to look-up the product indicated by the submitted purchase data and then to determine if there is a coupon available that is associated with the selected product. If an appropriate coupon is available, then the process 200 proceeds to step 222; otherwise, the process 200 proceeds to step 216.

At step 222, the process delivers the coupon associated with the selected product to the mobile device 9 associated with the respective buyer 22 that is using the system 10. Delivering the coupon may also be described as “pushing” the coupon to the buyer's mobile device 9. In use, when a buyer 22 selects an item for purchase, such as by scanning the product's bar code or QR code, a coupon is automatically delivered to the buyer's phone. In an embodiment, all of the coupons may be held until all purchases have been made and the buyer is ready to check-out. Then, all coupons can be “pushed” during or at the conclusion of checkout. Also at step 222, the processor 16 marks the coupon record 34 in the seller database 30 as having been redeemed so that the same coupon cannot be redeemed more than once by the same buyer. The process then proceeds to step 224.

If the processor 16 determined at step 214 that no coupon was available and associated with the product indicated by the submitted purchase data, then the process proceeds to step 216. At step 216, the processor 16 will search the product records 32 of the seller database for a product that can be considered as an equivalent of the originally selected product for which no coupon was available. It is understood that more sophisticated parameters for this equivalency selection process may be devised than are disclosed herein. When a potential alternative product choice is determined, the processor 16, under program control, determines if a coupon is associated therewith. The process 200 then proceeds to step 218.

At step 218, the processor 16 delivers a notification to the mobile device 9 associated with the member buyer 22 that an alternative product with coupon has been located (as a result of no coupon being available for the buyer-selected product). Step 218 also includes the processor 16 determining if the member buyer 22 chooses the alternative product and coupon and, if so, the process 200 proceeds to step 222 (described above); otherwise, the process 200 proceeds to step 220.

At step 220, the processor 16 determines if the member buyer 22 prefers to purchase the original user-selected product even though no coupon is associated therewith rather than purchase the alternative product selection for which there is a coupon. For instance, a buyer might be partial to a certain food brand and unwilling to purchase an alternative even if the alternative brand is cheaper with a coupon. If the member buyer 22 chooses to purchase the original selection, the process 200 proceeds to step 224; otherwise, the process 200 proceeds to step 226.

At step 224, the processor 16 records the product identification information of the product selected for purchase. Specifically, the product identification information may be the UPC or QR code scanned by the member buyer's mobile device 9 that was initially selected by the member buyer 22 and for which a coupon was available (from step 214), the alternative product suggested by the processor 16 (from step 218), or the product initially selected by the member buyer 22 even though no coupon was available (from step 220). With reference again to step 224, the processor 16 also records the identification of any coupon that is available and associated with the selected product. The process 200 proceeds from step 224 to step 226.

At step 226, the processor 16 determines if the member buyer 22 desires to end making purchases and, if so, the process 200 proceeds to step 230; otherwise, the process 200 proceeds to step 228. At step 228, the coupon records are updated. Specifically, if member sellers have uploaded additional coupon data as described previously, it may be stored in respective data structures at step 228. The process 200 then proceeds to step 212 so that a member buyer 22 may continue the process of selecting products for purchase. Products are selected for purchase by scanning respective UPC or QR codes.

At step 230, the processor 16 causes advertisements, coupons, or other messages to be delivered to the mobile device 9 associated with the logged in member buyer 22. These advertisements, coupons, and the like are generated by respective sellers and uploaded to the seller database 30 as described previously and may be specifically targeted to the member buyer 22 based on data in the respective buyer profile record 42. The process 200 then proceeds to step 232.

At step 232, the processor 16 again prompts the buyer to determine if he desires to continue shopping and, if so, the process 200 returns to step 228 and the shopping event continues. Otherwise, the process 200 proceeds to step 234. It is important to notice that step 230 and step 232 are an attempt to prolong a buyer's shopping experience after the buyer indicated a desire to stop at step 226 by delivering more ads and coupons to his mobile device.

At step 234, the processor 16 stores all of a buyer's selected products in the purchase history record 44 associated with the respective member buyer 22. The process 200 then proceeds to process 500 which corresponds to a purchase checkout routine.

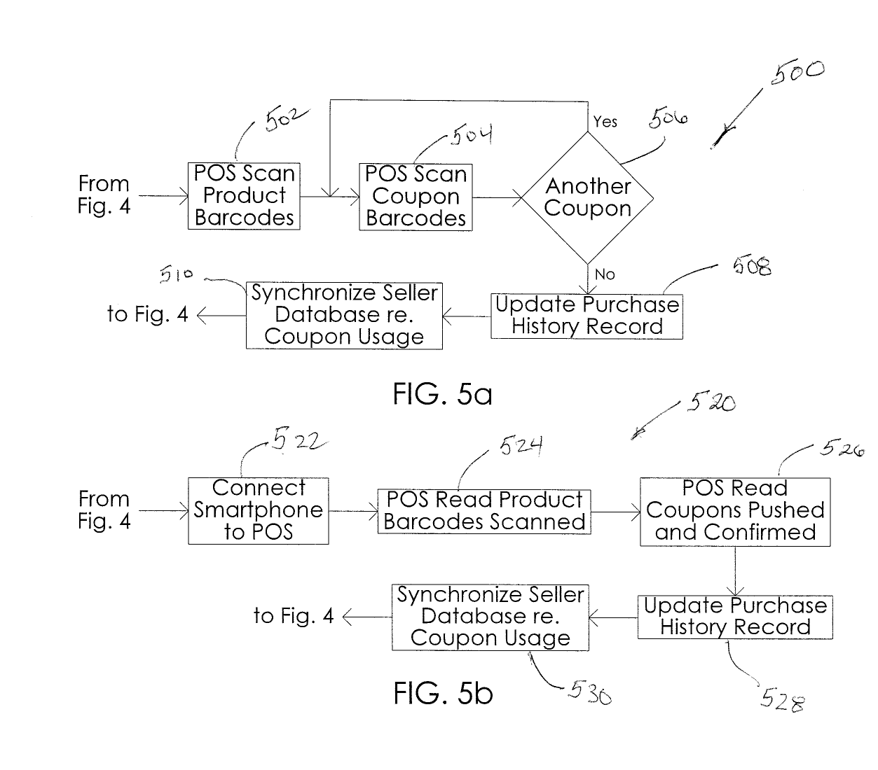

FIG. 5a represents a checkout process 500 in which each coupon pushed to the respective buyer is displayed on the mobile device 9 and scanned by a point-of-sale device in a store, such as by a traditional UPC scanner. By contrast, FIG. 5b represents a checkout process in which the processor 16 processes all coupons automatically and without individual scanning by or presenting to a point-of-sale scanner.

More particularly, at step 502, a point-of-sale (“POS”) scanner scans the barcodes of the products selected by a respective buyer as described previously. All selected products are logged and recorded by the processor 16 and can then be presented one by one at a POS register much in the manner of traditional shopping and checkout. The process 500 then proceeds to step 504. At step 504, each coupon pushed to the buyer's mobile device 9 may be similarly scanned in a one-by-one routine. The process 500 then proceeds to step 506. At step 506, the processor 16 determines if there is another coupon to present and scan and, if so, the process 500 returns to step 504; otherwise, control proceeds to step 508. At step 508, the purchase history record 44 associated with the respective buyer is updated once all products and coupons have been processed. The process 500 proceeds to step 510 where the seller database 30 is updated regarding coupons that have now been redeemed by the member buyer 22.

According to process 520 illustrated in FIG. 5b, the member buyer's mobile device 9 may be electrically connected to a point-of-sale (“POS”) device as indicated at step 522. The process 520 then proceeds to step 524 at which all of the selected product barcodes are downloaded into the POS and cost calculations on the purchases are made. In other words, all of the product identifying codes are scanned simultaneously and automatically without any action by the buyer or clerk. The process 520 proceeds to step 526 at which all coupons that have been pushed to the buyer's mobile device 9 are processed simultaneously and automatically without any action by the buyer or clerk. At step 528, the purchase history record 44 associated with the respective buyer is updated once all products and coupons have been processed. The process 500 proceeds to step 530 where the seller database 30 is updated regarding coupons that have now been redeemed by the member buyer 22.

It is understood that while certain forms of this invention have been illustrated and described, it is not limited thereto except insofar as such limitations are included in the following claims and allowable functional equivalents thereof.

1. An online automatic discount system for use with a wide area network and interfaced mobile device, comprising:
a computer server having a processor connected to the wide area network and that provides a user interface to the network and accessible from the interfaced mobile device;
programming and data structures stored in a computer readable memory in data communication with said processor;
a seller database stored in said memory that includes a plurality of member seller records, each member seller record including a seller identifier, a plurality of product records, and a plurality of coupon records associated with respective product records;
a buyer database stored in said memory that includes a plurality of member buyer records, each member buyer record including a member buyer identifier and a purchase history record;
programming in said memory that, when executed by said processor, causes said processor to:
receive purchase data from a respective buyer indicative of a product selected by an interfaced mobile device associated with the respective buyer;
determine from said seller database if a coupon is available and associated with the product selected by the respective buyer and, if so, deliver the coupon to the interfaced mobile device associated with the respective buyer.

2. The automatic discount system as in claim 1, comprising programming in said memory that, when executed by said processor, causes said processor to mark said delivered coupon in said seller database as having been redeemed so that said delivered coupon is not redeemed again by the respective buyer.

3. The automatic discount system as in claim 1, comprising programming in said memory that, when executed by said processor, causes said processor to:
determine if the respective buyer desires to continue selecting products using the respective interfaced mobile device and, if so, receive additional purchase data in due course; and
selectively receive an updated coupon record from a respective member seller into said seller database and synchronize said received record with respective coupon records.

4. The automatic discount system as in claim 1, comprising programming in said memory that, when executed by said processor, causes said processor to:
if said processor determined that no coupon is available and associated with said received purchase data, determine from said seller database an alternative product substantially equivalent to the product associated with said received purchase data;
determine from said seller database if a coupon is available and associated with said alternative product;
deliver notice of the coupon associated with said alternative product to the interfaced mobile device associated with the respective buyer.

5. The automatic discount system as in claim 4, comprising programming in said memory that, when executed by said processor, causes said processor to determine if the respective buyer confirms a choice to utilize said coupon associated with said alternative product and, if so, deliver said coupon associated with said alternative product to the interfaced mobile device associated with the respective buyer.

6. The automatic discount system as in claim 5, comprising programming in said memory that, when executed by said processor, causes said processor to mark in said seller database that said delivered coupon associated with said alternative product has been redeemed so that said delivered coupon is not redeemed again by the respective buyer.

7. The automatic discount system as in claim 5, comprising programming in said memory that, when executed by said processor, causes said processor to determine if the respective buyer has selected to purchase the product associated with said purchase data without the benefit of a coupon and, if so, record said purchase selection in said purchase history record in said buyer database associated with the respective buyer.

8. The automatic discount system as in claim 7, comprising programming in said memory that, when executed by said processor, causes said processor to:
determine if the respective buyer desires to continue selecting products using the respective interfaced mobile device and, if so, receive additional purchase data in due course; and
selectively receive an updated coupon record from a respective member seller into said seller database and synchronize said received record with respective coupon records.

9. The automatic discount system as in claim 6, comprising programming in said memory that, when executed by said processor, causes said processor to:
determine if the respective buyer desires to continue selecting products using the respective interfaced mobile device and, if so, receive additional purchase data in due course; and
selectively receive an updated coupon record from a respective member seller into said seller database and synchronize said received record with respective coupon records.

10. The automatic discount system as in claim 8, comprising programming in said memory that, when executed by said processor, causes said processor to:
determine if the respective buyer is finished selecting products;
record all purchase selections in said purchase history record associated with the respective buyer if said buyer is determined to be finished selecting products.

11. The automatic discount system as in claim 1, comprising programming in said memory that, when executed by said processor, causes said processor to display a purchase history record associated with the respective buyer.

12. The automatic discount system as in claim 1, comprising programming in said memory that, when executed by said processor, causes said processor to display said plurality of coupon records.

13. The automatic discount system as in claim 1, comprising a buyer profile database having a plurality of member buyer profile records, each member buyer profile record having buyer personal, contact, and demographic data.

14. The automatic discount system as in claim 6, comprising programming in said memory that, when executed by said processor, causes said processor to:
receive product data from a member seller;
receive coupon data associated with respective product data, said coupon data being indicative of coupons available to respective buyers upon selection of associated products for purchase.

15. A computer-implemented method for automatically offering coupon discounts to buyers upon selection of associated products for purchase using an interfaced mobile telephone, comprising the steps:
providing a seller database stored in a computer memory that includes a plurality of member seller records, each member seller record including a seller identifier, a plurality of product records, and a plurality of coupon records associated with respective product records;
providing a buyer database stored in said memory that includes a plurality of member buyer records, each member buyer record including a member buyer identifier and a purchase history record;
wherein said seller database and said buyer database are accessible to the mobile telephone through a user-interface;
receiving purchase data from a respective buyer indicative of a product selected by the interfaced mobile device associated with the respective buyer;
determining from said seller database if a coupon is available and associated with the product selected by the respective buyer and, if so, delivering the coupon to the interfaced mobile device associated with the respective buyer.

16. The method for automatically offering coupon discounts as in claim 15, including the step of marking said delivered coupon in said seller database as having been redeemed so that said delivered coupon is not redeemed again by the respective buyer.

17. The method for automatically offering coupon discounts as in claim 15, further including the steps of:
determining from said seller database an alternative product substantially equivalent to the product associated with said received purchase data if said processor determined that no coupon is available and associated with said received purchase data;
determining from said seller database if a coupon is available and associated with said alternative product and, if so,
delivering notice of the coupon associated with said alternative product to the interfaced mobile device associated with the respective buyer.

18. The method for automatically offering coupon discounts as in claim 17, including the step of determining if the respective buyer confirms a choice to utilize said coupon associated with said alternative product and, if so, delivering said coupon associated with said alternative product to the interfaced mobile device associated with the respective buyer.

19. The method for automatically offering coupon discounts as in claim 15, including the step of determining if the respective buyer has selected to purchase the product associated with said purchase data without the benefit of a coupon and, if so, record said purchase selection in said purchase history record in said buyer database associated with the respective buyer.

20. The method for automatically offering coupon discounts as in claim 15, including the steps of:
marking said delivered coupon in said seller database as having been redeemed so that said delivered coupon is not redeemed again by the respective buyer;
determining if the respective buyer desires to continue selecting products using the respective interfaced mobile device and, if so, receiving additional purchase data in due course; and
selectively receiving an updated coupon record from a respective member seller into said seller database and synchronizing said received record with respective coupon records.

21. The method for automatically offering coupon discounts as in claim 15, further comprising the steps of:
providing a point-of-sale (“POS”) device configured to electrically connect with the mobile device associated with the respective buyer;
automatically reading all purchase data from the mobile device when electrically connected to said POS; and
automatically reading all coupons delivered to the mobile device when electrically connected to said POS.

22. The method for automatically offering coupon discounts as in claim 15, further comprising the step of determining if the respective buyer desires to continue selecting products using the respective mobile device and, if not, delivering advertising messages to the mobile device associated with the respective buyer that are intended to persuade the respective buyer reconsider the decision to not continue selecting products.
